(19) United States
(12) Patent Application Publication
(10) Pub. No.: US 2014/0179235 A1
(43) Pub. Date: Jun. 26, 2014

(54) METHOD FOR REDUCING POWER CONSUMPTION AND COMMUNICATIONS APPARATUS UTILIZING THE SAME

(71) Applicant: MEDIATEK INC., Hsin-Chu (TW)

(72) Inventor: Ting-Chang HUANG, Taoyuan City (TW)

(73) Assignee: MediaTek Inc., Hsin-Chu (TW)

(21) Appl. No.: 13/722,045

(22) Filed: Dec. 20, 2012

(51) Int. Cl. H04B 7/04

(52) U.S. Cl. CPC H04B 7/0413
USPC 455/63.4

(57) ABSTRACT

A communications apparatus having multiple antennas for supporting MIMO communications includes a processor coupled to at least a radio transceiver, a baseband processing element and the antennas. The processor at least includes a first processor logic unit for determining a value of an indicator according to a plurality of signals received from an air interface via the radio transceiver and a second processor logic unit for dynamically adjusting a number of antennas utilized in following receiving operations based on the value of the indicator. The signals are transmitted by a peer communications apparatus via one or more transmitting antennas and the indicator is capable of reflecting qualities of the signals.

### BACKGROUND OF THE INVENTION

1. Field of the Invention

The invention relates to a method for reducing power consumption in communications apparatuses.

2. Description of the Related Art

The term “wireless” normally refers to an electrical or electronic operation that is accomplished without the use of a “hard wired” connection. “Wireless communications” is the transfer of information over a distance without the use of electrical conductors or wires. The distances involved may be short (a few meters for television remote controls) or very long (thousands or even millions of kilometers for radio communications). The best known example of wireless communications is the cellular telephone. Cellular telephones use radio waves to enable an operator to make phone calls to other parties from many locations world-wide. They can be used anywhere, as long as there is a cellular telephone site to house equipment that can transmit and receive signals, which are processed to transfer both voice and data to and from the cellular telephones.

Along with the development in wireless communications technology, the bandwidth and data throughput requirements are rapidly growing since wireless communications is applied from simply voice transmission to data transmission. High data throughput implies a great amount of data to be processed, and therefore a great amount of power consumption is required. Since wireless communications apparatuses are now commonly powered by batteries, methods for reducing power consumption in modern wireless communications apparatuses are desired.

### BRIEF SUMMARY OF THE INVENTION

A communications apparatus and method for reducing power consumption in a communications apparatus are provided. An exemplary embodiment of a communications apparatus having a plurality of antennas for supporting Multiple-Input Multiple-Output (MIMO) communications comprises a processor coupled to at least a radio transceiver, a baseband processing element and the antennas. The processor at least comprises a first processor logic unit for determining a value of an indicator according to a plurality of signals received from an air interface via the radio transceiver and a second processor logic unit for dynamically adjusting a number of antennas utilized in following receiving operations based on the value of the indicator. The signals are transmitted by a peer communications apparatus via one or more transmitting antennas and the indicator is capable of reflecting qualities of the signals.

An exemplary embodiment of a method for reducing power consumption in a communications apparatus having a plurality of antennas for supporting Multiple-Input Multiple-Output (MIMO) communications comprises: determining a value of an indicator according to a plurality of signals received from an air interface via a radio transceiver of the communications apparatus, wherein the signals are transmitted by a peer communications apparatus via one or more transmitting antennas and the indicator is capable of reflecting qualities of the signals; dynamically adjusting a number of antennas utilized in following receiving operations of the communications apparatus based on the value of the indicator. When the value of the indicator has exceeded a predetermined threshold, a single antenna of the communications apparatus is determined to be utilized in following receiving operations.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a block diagram of a communications apparatus according to an embodiment of the invention;

FIG. 2 is a diagram showing a method for determining the number of antennas to be utilized according to an embodiment of the invention;

FIG. 3 is a diagram showing a method for determining the number of antennas to be utilized according to another embodiment of the invention;

FIG. 4 is a diagram showing a method for determining the number of antennas to be utilized according to yet another embodiment of the invention;

FIG. 5 shows a flow chart of a method for reducing power consumption in a communications apparatus according to an embodiment of the invention;

FIG. 6 shows a flow chart of a method for determining the number of antennas to be utilized in following receiving operations of a communications apparatus according to an embodiment of the invention; and

FIG. 7 shows a flow chart of a method for determining the number of antennas to be utilized in following receiving operations of a communications apparatus according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

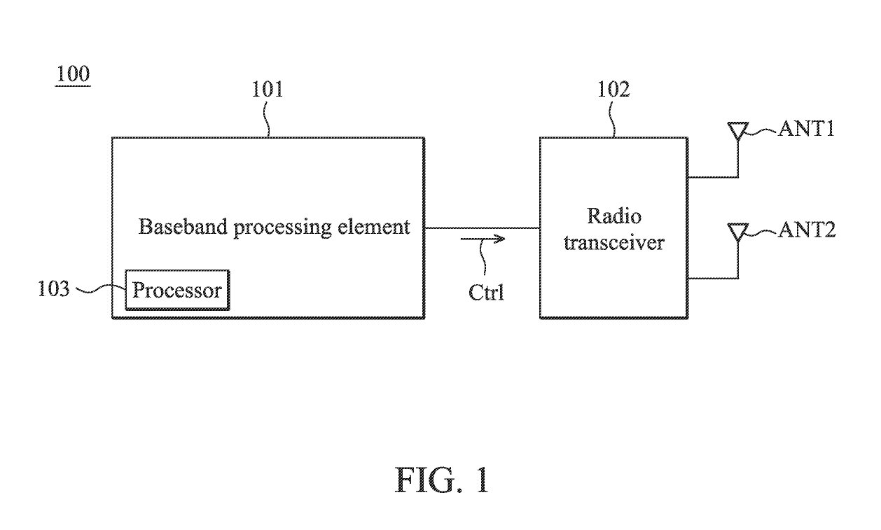

FIG. 1 shows a block diagram of a communications apparatus according to an embodiment of the invention. The communications apparatus 100 may comprise a baseband processing element 101, a radio transceiver 102, a processor 103 and at least two antennas ANT1 and ANT2. The radio transceiver 102 may receive wireless radio frequency signals via one or both of the antennas ANT1 and ANT2, convert the received signals to baseband signals to be processed by the baseband processing element 101, or receive baseband signals from the baseband processing element 101 and convert the received signals to wireless radio frequency signals to be transmitted to a peer communications element. The radio transceiver 102 may comprise a plurality of hardware elements to perform radio frequency conversion. For example, the radio transceiver 102 may comprise a mixer to multiply the baseband signals with a carrier oscillated in the radio frequency of the wireless communications system, such as a Universal Mobile Telecommunications System (UMTS) system, a Long Term Evaluation (LTE) system, a Worldwide Interoperability for Microwave Access (WiMAX) system, a Wireless Local Area Network (WLAN) system, or others.

The baseband processing element 101 may further convert the baseband signals to a plurality of digital signals, and process the digital signals, and vice versa. The baseband processing element 101 may also comprise a plurality of hardware elements to perform baseband signal processing, such as the processor 103, which may be a digital signal processor, or others. The baseband signal processing may comprise analog to digital conversion (ADC)/digital to analog conversion (DAC), gain adjustments, modulation/demodulation, encoding/decoding, and so on. Note that in some embodiments of the invention, the communications apparatus 100 may further comprise another central processor configured outside of the baseband processing element 101 for controlling the operations of the baseband processing element 101, the radio transceiver 102, and a memory element (not shown) which stores the system data and program codes of the communications apparatus 100. Note further that in still some embodiments of the invention, the processor 103 may also be configured outside of the baseband processing element 101 as the central processor for controlling the operations of the baseband processing element 101, the radio transceiver 102, and the memory element, and therefore, the invention should not be limited to the architecture as shown in FIG. 1.

According to an embodiment of the invention, the processor 103 may be arranged to execute the program codes of the corresponding software module(s) of the baseband processing element 101 and/or the radio transceiver 102. The program codes accompanied with specific data in a data structure may also be referred to as a processor logic unit or a stack instance when being executed. Therefore, the processor 103 may be regarded as comprising a plurality of processor logic units each for executing one or more specific functions or tasks of the corresponding software module(s).

Generally, when a communications apparatus has Multiple-Input Multiple-Output (MIMO) capability, the communications apparatus should support at least two receiving paths to receive data from a peer communications apparatus, such as a base station (BS) or an evolved node B (eNB). For example, when the peer communications apparatus uses one or more transmitting antennas to transmit one data stream out into the air interface, the communications apparatus 100 may apply an antenna diversity (also called space diversity) scheme by using multiple antennas to receive the data stream, so as to improve the quality and reliability of the wireless link, and further mitigate interference and multipath fading contributed by the communication channels in the air interface. On the other hand, when multiple data streams are transmitted by the peer communications apparatus, the communications apparatus 100 may use multiple antennas to receive the data streams, wherein each antenna is directed to receive a dedicated data stream, so as to improve the data throughput. As an example, the data throughput may be doubled when the communications apparatus 100 uses two antennas to receive two different data streams. Therefore, when there are multiple antennas equipped in a communications apparatus, these antennas are preferably designed as being always activated and utilized at the same time for either improving the quality and reliability of the wireless link or improving the data throughput.

However, because the wireless communications apparatuses are now commonly powered by battery, power consumption is an issue worthy of concern. Therefore, in the following paragraphs, methods for reducing power consumption in modern wireless communications apparatuses are provided.

According to an embodiment of the invention, after receiving a plurality of signals from the air interface via the radio transceiver 102, the processor 103 (for example, a processor logic unit of the processor 103) may first determine a value of an indicator according to the currently received signals. In the embodiment of the invention, the indicator may be flexibly designed, as long as the indicator is capable of reflecting qualities of the currently received signals. In addition, the indicator may also be any indicator that is capable of reflecting the receiver requirement for receiving the control and/or paging channel data. For example, according to an embodiment of the invention, the indicator may be the Reference Signal Receiving Quality (RSRQ) of the currently received signals. According to another embodiment of the invention, the indicator may be the Reference Signal Receiving Power (RSRP) of the currently received signals. According to yet another embodiment of the invention, the indicator may be the Signal to Noise Ratio (SNR) of the currently received signals, multiple SNRs obtained over a period of time, a derivative of the SNRs, a variation of the SNRs, or the like. Note that the currently received signals may be transmitted by the peer communications apparatus via one or more transmitting antennas.

After obtaining the value of the indicator capable of reflecting qualities of the currently received signals or the receiver requirement of the communications apparatus 100, the processor 103 (for example, a processor logic unit of the processor 103) may dynamically adjust a number of antennas utilized in following receiving operations based on the value of the indicator. For example, the processor 103 may issue a control signal Ctrl as shown for controlling the radio transceiver 102 to dynamically adjust the number of antennas utilized in following receiving operations. In order to reduce power consumption in following receiving operations of the communications apparatus 100, based on the concept of the invention, the processor 103 may determine to use a single antenna in following receiving operations of the communications apparatus 100 when the value of the indicator has exceeded a predetermined threshold.

Note that in the embodiments of the invention, the communications apparatus 100 may use a single antenna in receiving operations when, as an example and not to be used in a limiting sense, the peer communications apparatus adopts a MIMO or a Single-input Multiple-Output (SIMO) (e.g. transmit diversity) transmission mode for downlink transmission, or when, as another example and not to be used in a limiting sense, the peer communications apparatus is configured for communication using the Downlink Control Information (DCI) format 1A or 1C (that is, the peer communications apparatus is configured to use a single antenna for downlink transmission).

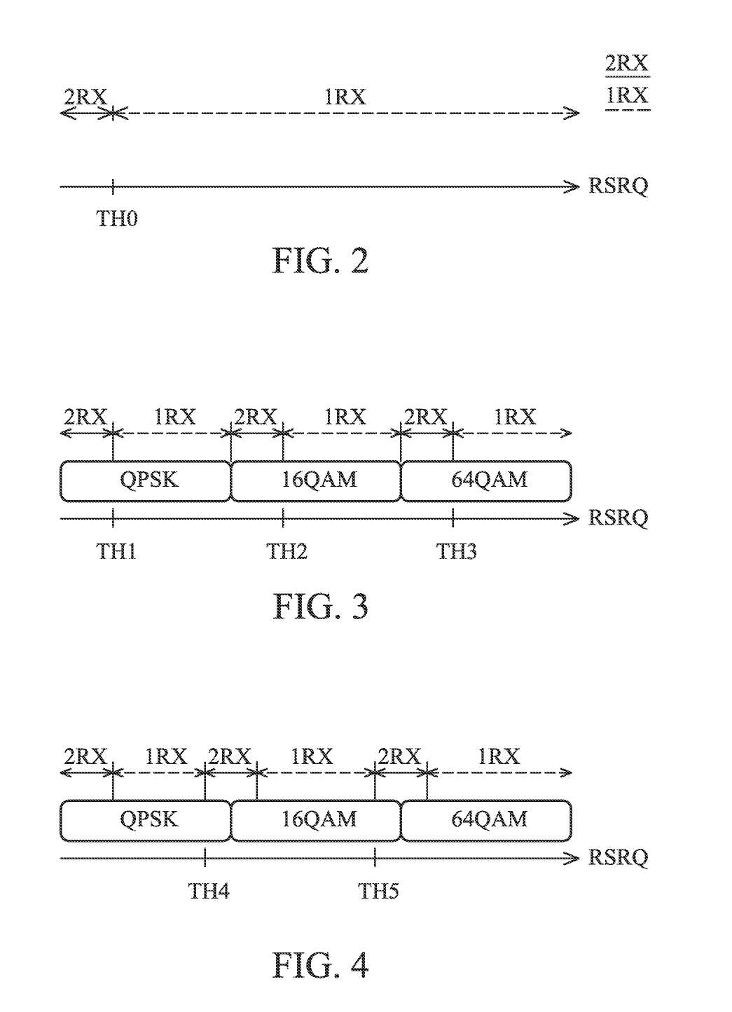

FIG. 2 is a diagram showing a method for determining the number of antennas to be utilized according to an embodiment of the invention. As shown in FIG. 2, when the RSRQ of the received signals has exceeded the threshold TH0, the processor 103 may determine to use a single antenna (labeled as 1RX) in following receiving operations. Otherwise, the processor 103 may determine to use two antennas (labeled as 2RX) in following receiving operations.

According to another embodiment of the invention, there may be multiple thresholds designed for different modulation schemes. FIG. 3 is a diagram showing a method for determining a number of antennas to be utilized according to another embodiment of the invention. As shown in FIG. 3, when a Quadrature Phase Shift Keying (QPSK) modulation is utilized for modulating the downlink signals, the processor 103 may determine to use a single antenna (labeled as 1RX) in following receiving operations when the RSRQ of the received signals has exceeded the threshold TH1, or alternatively the processor 103 may determine to use two antennas (labeled as 2RX) in following receiving operations. When a 16 Quadrature Amplitude Modulation (16QAM) modulation is utilized for modulating the downlink signals, the processor 103 may determine to use a single antenna (labeled as 1RX) in following receiving operations when the RSRQ of the received signals has exceeded the threshold TH2, or alternatively the processor 103 may determine to use two antennas (labeled as 2RX) in following receiving operations. When a 64 Quadrature Amplitude Modulation (64QAM) modulation is utilized for modulating the downlink signals, the processor 103 may determine to use a single antenna (labeled as 1RX) in following receiving operations when the RSRQ of the received signals has exceeded the threshold TH3, or alternatively the processor 103 may determine to use two antennas (labeled as 2RX) in following receiving operations.

FIG. 4 is a diagram showing a method for determining the number of antennas to be utilized according to yet another embodiment of the invention. In the embodiment, in order to further improve the data throughput as much as possible, the processor 103 may determine to use two antennas (labeled as 2RX) in following receiving operations when the RSRQ of the received signals has further exceeded the thresholds TH4 or TH5. Take the QPSK modulation scheme as an example: the processor 103 may determine to use a single antenna (labeled as 1RX) in following receiving operations when the RSRQ of the received signals has exceeded the threshold TH1 as shown in FIG. 3 or alternatively the processor 103 may determine to use two antennas (labeled as 2RX) in following receiving operations. However, when the RSRQ of the received signals has further exceeded the threshold TH4, the processor 103 may determine to use two antennas (labeled as 2RX) in following receiving operations for improving the signal quality and getting a chance to switch to a higher data-rate modulation scheme (for example, the 16QAM). Once the peer communications apparatus has detected that the signal quality has improved, the peer communications apparatus may modulate the downlink signals by using another modulation scheme (for example, the 16QAM) having a higher data rate than the original one (for example, the QPSK) so that the data throughput may be further improved.

Note that the indicator RSRQ, the modulation schemes QPSK, 16QAM and 64QAM, and the number of antennas as shown are merely examples used to clearly illustrate the concept of the invention, and the invention should not be limited thereto. Those who are skilled in this technology can easily make various alterations and modifications without departing from the scope and spirit of this invention by using different indicators, different modulation schemes, and/or a different number of antennas (for example, more than two antennas). Therefore, the scope of the present invention shall be defined and protected by the claims and their equivalents as described below.

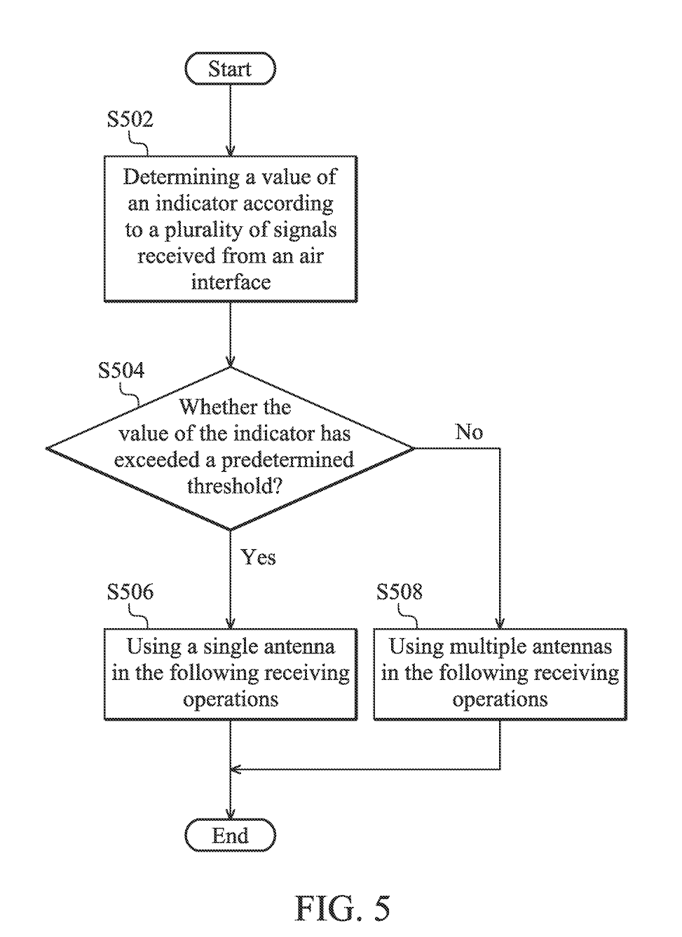

FIG. 5 shows a flow chart of a method for reducing power consumption in a communications apparatus according to an embodiment of the invention. First of all, the processor may determine the value of an indicator according to a plurality of signals received from an air interface (Step S502). Next, the processor may dynamically adjust the number of antennas utilized in following receiving operations of the communications apparatus based on the value of the indicator by determining whether the value of the indicator has exceeded a predetermined threshold (Step S504). When the value of the indicator has exceeded the predetermined threshold, the processor may determine to use a single antenna in following receiving operations (Step S506). Otherwise, the processor may determine to use multiple antennas in following receiving operations (Step S508).

According to an embodiment of the invention, the processor 103 (for example, a processor logic unit of the processor 103) may determine the value of the indicator according to one or more cell-specific pilots in the signals. Cell-specific pilots are used for channel estimation and may span entire downlink cell bandwidth. In addition, in some embodiments of the invention, the processor 103 (for example, a processor logic unit of the processor 103) may further dynamically determine a margin of the predetermined threshold according to channel characteristics of the air interface and apply the margin to the predetermined threshold to achieve better data throughput performance. When the margin is applied, the processor 103 (for example, a processor logic unit of the processor 103) may determine to use a single antenna in following receiving operations when the value of the indicator has exceeded the predetermined threshold plus a value of the margin, or alternatively use multiple antennas in following receiving operations. For example, when the predetermined threshold is set to 22 dB and the margin is set to 2 dB, the processor 103 may determine to use a single antenna in following receiving operations when the value of the indicator has exceeded 24 dB instead of 22 dB.

The reason for applying the margin on the predetermined threshold is that the timing of switching the number of antennas can be varied with different channel characteristics. For example, when the channel is very stable and/or the moving speed of the communications apparatus 100 is slow, the margin may be reduced so that the communications apparatus 100 may keep using a single antenna as long as possible to reduce power consumption, since the channel quality is good. On the other hand, when the channel is unstable and/or the moving speed of the communications apparatus 100 is fast, the margin may be increased so that the communications apparatus 100 may switch from a single antenna to multiple antennas earlier when the signal quality drops, to maintain desirable signal quality and prevent a drop in the data rate due to the modulation scheme being downgraded as determined by the peer communications apparatus.

According to another embodiment of the invention, the communications apparatus 100 may also determine to switch from using a single antenna to multiple antennas when data cannot be decoded correctly. For example, the communications apparatus 100 may initially use a single antenna to receive data carried in a control channel, such as a Physical Downlink Control Channel (PDCCH). However, the communications apparatus 100 may later determine to switch from using a single antenna to multiple antennas when the data carried in a data channel, such as a Physical Downlink Shared Channel (PDSCH), cannot be decoded correctly.

According to yet another embodiment of the invention, the communications apparatus 100 may also determine that a number of antennas be utilized in following receiving operations further based on the current operation mode, such as an idle (sometimes called standby) mode or a link (or connected) mode of the communications apparatus 100, the current transmission mode adopted by the peer communications apparatus, and the value of the indicator. For example, when the communications apparatus 100 is operating in idle mode, the communications apparatus 100 may directly determine to use a single antenna in following receiving operations, regardless of whether the value has exceeded the predetermined threshold or not. For another example, when the communications apparatus 100 is operating in idle mode and when the value has exceeded the predetermined threshold, the communications apparatus 100 may determine to use a single antenna in following receiving operations.

On the other hand, when the communications apparatus 100 is operating in the connected mode (that is, having a dedicated connection established for voice or data transmission with the peer communications apparatus), the communications apparatus 100 may determine that a number of antennas be utilized in following receiving operations based on the transmission mode and/or the value of the indicator.

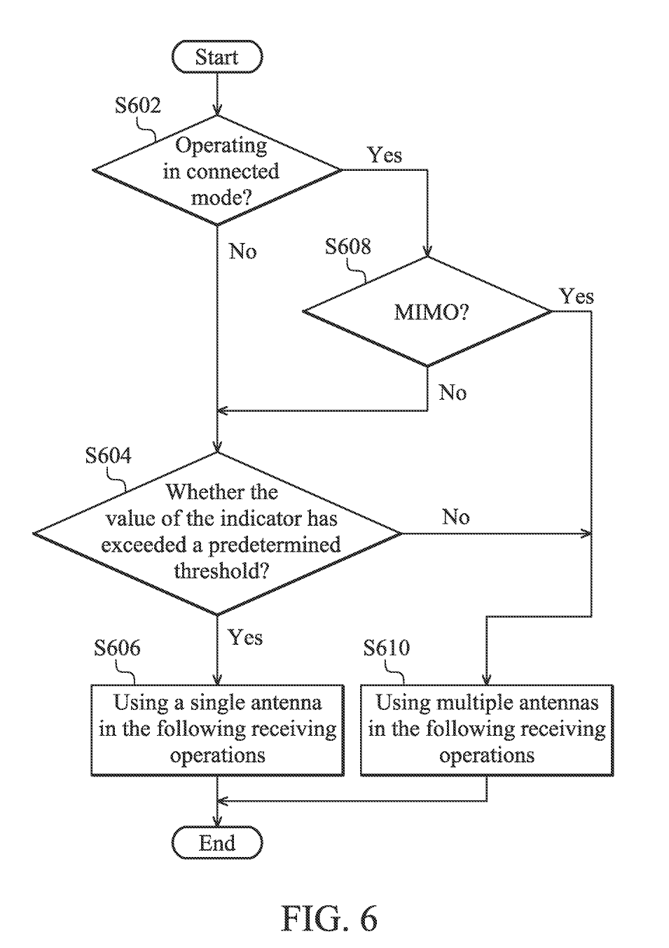

FIG. 6 shows a flow chart of a method for determining that a number of antennas be utilized in following receiving operations of a communications apparatus according to another embodiment of the invention. The processor 103 may first determine whether the communications apparatus (that is, the processor) is operating in connected mode (Step S602). When the communications apparatus is not operating in connected mode, the processor 103 may further determine whether the value of the indicator has exceeded a predetermined threshold. (Step S604). If so, the processor 103 may determine to use a single antenna in following receiving operations (Step S606). If not, the processor 103 may determine to use multiple antennas in following receiving operations (Step S610). On the other hand, when the communications apparatus is operating in connected mode, the processor 103 may further determine whether a MIMO transmission mode is applied (Step S608). If so, the processor 103 may directly determine to use multiple antennas in following receiving operations (Step S610). If not, the processor 103 may further determine whether the value of the indicator has exceeded a predetermined threshold. (Step S604). If so, the processor 103 may determine to use a single antenna in following receiving operations (Step S606). If not, the processor 103 may determine to use multiple antennas in following receiving operations (Step S610).

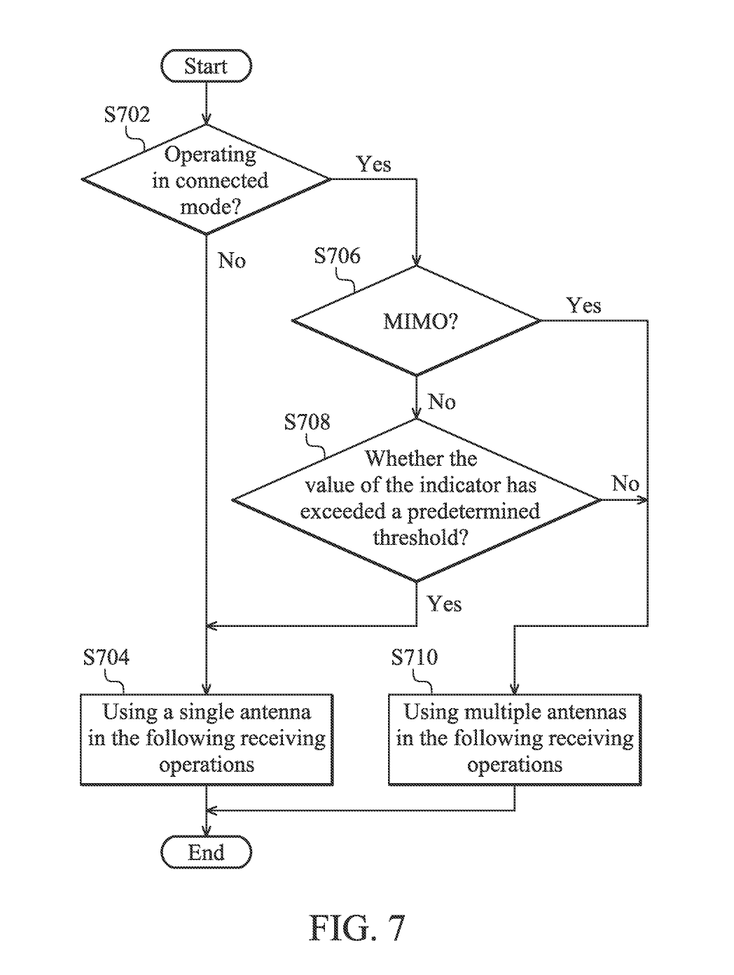

FIG. 7 shows a flow chart of a method for determining the number of antennas to be utilized in following receiving operations of a communications apparatus according to an embodiment of the invention. Different from the embodiment shown in FIG. 6, in this embodiment, the communications apparatus 100 may directly determine to use a single antenna in following receiving operations when operating in idle mode regardless of whether the value has exceeded the predetermined threshold or not. The processor 103 may first determine whether the communications apparatus (that is, the processor) is operating in connected mode (Step S702). When the communications apparatus is not operating in connected mode, the processor 103 may directly determine to use a single antenna in following receiving operations (Step S704). Otherwise, the processor 103 may further determine whether a MIMO transmission mode is applied (Step S706). If so, the processor 103 may directly determine to use multiple antennas in following receiving operations (Step S710). If not, the processor 103 may further determine whether the value of the indicator has exceeded a predetermined threshold. (Step S708). If so, the processor 103 may determine to use a single antenna in following receiving operations (Step S704). If not, the processor 103 may determine to use multiple antennas in following receiving operations (Step S710).

The above-described embodiments of the present invention can be implemented in any of numerous ways. For example, the embodiments may be implemented using hardware, software, or a combination thereof It should be appreciated that any component or collection of components that perform the functions described above can be generically considered as one or more processors that control the above discussed function. The one or more processors can be implemented in numerous ways, such as with dedicated hardware, or with general purpose hardware that is programmed using microcode or software to perform the functions described above.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus having a plurality of antennas for supporting Multiple-Input Multiple-Output (MIMO) communications, comprising:
a processor, coupled to at least a radio transceiver, a baseband processing element and the antennas, wherein the processor at least comprises:
a first processor logic unit, determining a value of an indicator according to a plurality of signals received from an air interface via the radio transceiver, wherein the signals are received from a peer communications apparatus via one or more receiving antennas, and the indicator is capable of reflecting qualities of the signals; and
a second processor logic unit, dynamically adjusting a number of antennas utilized in following receiving operations based on the value of the indicator.

2. The communications apparatus as claimed in claim 1, wherein when the value of the indicator has exceeded a predetermined threshold, the second processor logic unit determines to use a single antenna in the following receiving operations.

3. The communications apparatus as claimed in claim 1, wherein the indicator is a Reference Signal Receiving Quality (RSRQ) of the signals.

4. The communications apparatus as claimed in claim 1, wherein the indicator is a Reference Signal Receiving Power (RSRP) of the signals.

5. The communications apparatus as claimed in claim 1, wherein the indicator is a Signal to Noise Ratio (SNR) of the signals.

6. The communications apparatus as claimed in claim 1, wherein the first processor logic unit determines the value of the indicator according to one or more cell-specific pilots in the signals.

7. The communications apparatus as claimed in claim 1, wherein the processor further comprises a third processor logic unit dynamically determines a margin of a predetermined threshold according to channel characteristics of the air interface, and when the margin is applied, the second processor logic unit determines to use a single antenna in the following receiving operations when the value of the indicator has exceeded the predetermined threshold plus a value of the margin.

8. The communications apparatus as claimed in claim 1, wherein the processor further comprises a fourth processor logic unit determines whether the processor operates in an idle mode, and when the processor operates in the idle mode, the second processor logic unit determines to use a single antenna in the following receiving operations.

9. The communications apparatus as claimed in claim 1, wherein the processor is comprised in the baseband processing element.

10. A method for reducing power consumption in a communications apparatus having a plurality of antennas for supporting Multiple-Input Multiple-Output (MIMO) communications, comprising:
determining a value of an indicator according to a plurality of signals received from an air interface via a radio transceiver of the communications apparatus, wherein the signals are received from a peer communications apparatus via one or more receiving antennas and the indicator is capable of reflecting qualities of the signals; and
dynamically adjusting a number of antennas utilized in following receiving operations of the communications apparatus based on the value of the indicator,
wherein when the value of the indicator has exceeded a predetermined threshold, a single antenna is determined to be utilized in the following receiving operations of the communications apparatus.

11. The method as claimed in claim 10, wherein the indicator is a Reference Signal Receiving Quality (RSRQ) of the signals.

12. The method as claimed in claim 10, wherein the indicator is a Reference Signal Receiving Power (RSRP) of the signals.

13. The method as claimed in claim 10, wherein the indicator is a Signal to Noise Ratio (SNR) of the signals.

14. The method as claimed in claim 10, wherein the value of the indicator is determined according to one or more cell-specific pilots in the signals.

15. The method as claimed in claim 10, further comprising:
dynamically determining a margin of the predetermined threshold according to channel characteristics of the air interface,
wherein when the margin is applied, a single antenna is determined to be utilized in the following receiving operations of the communications apparatus when the value of the indicator has exceeded the predetermined threshold plus a value of the margin.

16. The method as claimed in claim 10, further comprising:
determining whether the communications apparatus operates in an idle mode, wherein when the communications apparatus operates in the idle mode, a single antenna of the communications apparatus is determined
